(19) United States
(12) Patent Application Publication
(10) Pub. No.: US 2003/0151689 A1
(43) Pub. Date: Aug. 14, 2003

(54) Digital images with composite exposure

(76) Inventor: Charles Douglas Murphy, Chicago, IL (US)

Correspondence Address: CHARLES DOUGLAS MURPHY, 601 LINDEN PLACE #210, EVANSTON, IL, 60202, US

(21) Appl. No.: 10/072,286

(22) Filed: Feb. 11, 2002

(51) Int. Cl. H04N 5/235

(52) U.S. Cl. 348/362

(57) ABSTRACT

A machine or method used for exposure adjustment in digital imaging. Two or more digital images form a set of digital images of a field of view. At least one pixel in one of the images comprises a digital number representative of a signal level of a sensor response to visible light. Digital images from the set are arithmetically combined to form a composite digital image of the field of view. The composite digital image can have different exposure properties than the component digital images, for instance differing exposure times and differing ranges of variation in the digital numbers representative of features in the field of view. The invention enables adjustment of exposure during arithmetic combination, so that the various features of the field of view in the composite image are neither overexposed nor underexposed unless such characteristics are desired. The invention enables enhancement of streaks or motion blur during combination, and also allows removal of streaks or motion blur. Composite pixels in the composite image can have differing exposure times, and differing combination functions can be used to produce the composite pixels. The invention can be used to produce a single composite image in such applications as digital photography. The invention can be used with flash photography or with passive imaging in ambient light. The invention can also be used to produce a sequence of composite images in such applications as movies, television programs, computer video sequences, and personal video recordings.

### CROSS-REFERENCE TO RELATED APPLICATIONS

Not applicable

### STATEMENT REGARDING FEDERALLY SPONSORED RESEARCH OR DEVELOPMENT

Not applicable

### REFERENCE TO A MICROFICHE APPENDIX

Not applicable

### BACKGROUND—FIELD OF INVENTION

The invention relates to digital imaging with visible light, particularly to combining two or more members of a sequence of digital images of a field of view to produce a composite digital image of the field of view having desired exposure properties.

### BACKGROUND—DESCRIPTION OF PRIOR ART

An image is acquired by exposing a sensor or a sensor array to incident energy and recording changes in sensor parameters. For a digital image, the changes are recorded as digital number values, whereas for an analog image measurements of the changes are analog quantities. The recorded changes are combined in a set to form the acquired image. Once acquired, the measurements in the set can be combined to form other, composite images.

One example of combining acquired images to produce composite images is photomontage. In photomontage, part or all of one image of one field of view is superimposed on another image of another field of view. For instance, one might create a composite image of a city skyline at night under the moon, with an image of the Earth taken from space in place of the moon.

The effect of photomontage is often artistic, with the images designed to suggest various ideas to the viewer or to elicit various emotions. The intent of photomontage is principally to create an artificial field of view—that is, one that never existed—whereby actual features from images of real fields of view can appear in the same image. Also, entirely artificial features can be included in photomontage images.

Radar waves and sound waves are two important imaging modalities. In each, there is usually a short, controlled pulse emitted in order to illuminate a field of view. Reflections of the pulse from features in the field of view constitute the incident energy in these systems. Usually, there are a relatively small number of sensors in a radar or an acoustic array. However, sensor parameter changes are recorded at a large number of distinct epochs for each sensor. While each set of measurements may technically be an acquired image, the various sets of measurements are combined to form a final composite image which is interpreted by trained observers.

In radar, underwater sonar, and ultrasound medical imaging, the combining of time-series measurements involves more than simple formation of sets. Measured sensor outputs are combined arithmetically in various ways. That is, measured sensor outputs are modified via multiplication, addition, truncation, and other mathematical operations that do more than simply define sets.

In contrast to radar and acoustic images, visible light images are often acquired by measuring the outputs of a large array at a single time epoch. Without further processing, the acquired image can be interpreted by untrained observers as a representation of the light incident on the sensor array during a very short time period. Often, the light is ambient light, though it is also possible to use active imaging techniques in the form of a controlled flash of visible light.

A prior art example of further processing of visible light images is image joining. In image joining, one image of one field of view and a second image of a second field of view which overlaps the first field of view are combined to form a composite image of a composite field of view. The principal aim of image joining is to form a panoramic image of a large field of view. As the large field of view did not exist during acquisition of either component image, the large field of view is an artificial field of view and not an actual field of view.

In image joining, the overlap between two fields of view is usually only a small portion of each, by design. Image joining techniques attempt to locate the overlapping regions and the features common to each. Then, one region can be cropped and the disjoint measurements of each image combined in a set to form the panoramic image. However, this may leave visually obvious artifacts such as boundary lines. More advanced techniques for image joining attempt to balance the exposure properties of the overlap region or of the overlap region and the remaining non-overlapping portions of one of the images. This balancing may use arithmetic combining means to produce a non-obvious transition between the two component images.

The closest prior art to the present invention is in the area of medical x-ray imaging. It is well known in the medical community that different types of body tissue have different absorption properties when exposed to x-rays. In fact, many medical x-ray techniques aimed at imaging tissue rely on the variations of absorption to produce variations in the desired image.

With respect to x-ray absorption properties, there are basically two types of tissue. Hard tissue, such as bone, exhibits one set of absorption properties. Soft tissue, such as muscle or soft organs, exhibits another set of absorption properties.

A low-energy x-ray may provide desired sensor output variation when imaging soft tissue, resulting in an image in which soft tissue features have a desired range of variation. The same x-ray may be strongly absorbed by hard tissue, so that hard tissue features in the acquired image do not have a desired range of variation. Similarly, an x-ray which provides a desired sensor output variation for hard tissue may provide unsatisfactory variation for soft tissue.

Prior art patents for medical x-ray imaging have proposed combining two or more different x-ray images to produce a composite image in which soft tissue has desired variation and in which hard tissue also has desired variation. This prior art is based on knowledge of the varying absorption properties of different tissue types and on the observation that the same features in different images may have differing exposure properties. However, the prior art is restricted to x-ray imaging and in particular to active x-ray imaging.

In visible light imaging, there are several techniques for acquiring a good image. An experienced photographer can manually select an exposure time duration and an aperture size that for a given illumination level will result in an image that is properly exposed. An inexperienced photographer may have to rely on luck for proper manual selection of exposure time duration and aperture size. Alternatively, automated selection of these settings may enable acquisition of a good image. However, automated camera setting selection is based on some assumptions about illumination conditions in the field of view. When actual conditions fail to match the assumed conditions, the acquired image may be of poor quality.

Once an image has been acquired, even an image that does not have desired exposure properties, it can be manipulated using image processing software. Usually, the image must be digitized at some point to form a digital image. Digital number values of the digital image can be changed quite easily to give an image that is overexposed or underexposed the appearance of proper exposure. Also, the visual effects of motion or other artifacts of image acquisition can be enhanced or reduced using image processing software.

Regardless of how much image processing is carried out on a single acquired digital image, it is not possible to recover the detailed exposure information that is lost once the sensor numbers have been quantized and stored as digital numbers. Thus, exposure adjustment and enhancement or reduction of motion effects is an artificial process.

For a digital image of good quality, the digital number values that represent interesting features in the field of view should have a desired range of variation. In visible light imaging, as in medical x-ray imaging, it may be the case that different features in a field of view have different dynamic ranges. Moreover, different observers of a visible light digital image may find different features to be of interest. Since the properties of the features of interest are not known in advance, it would be useful to have a digital imaging technique for visible light which preserves as much information as possible about sensor output variation and allows amateur photographers to easily create high-quality digital images without artificial compensation for unwanted effects.

### SUMMARY

The present invention is a digital imaging technique which enables image processing hardware or software to produce a composite digital image of a field of view from a set of digital images of the field of view, in visible light and with or without a flash.

### OBJECTS AND OBJECTIVES

There are several objects and objectives of the present invention.

It is an object of the present invention to allow production of a composite digital image having desired exposure properties, where the composite digital image is formed by arithmetically combining members of a set of two or more digital images of a field of view. The composite digital image of the field of view can be properly exposed when the digital images are underexposed. Alternatively, the composite digital image can be made to be underexposed or overexposed as desired.

It is an object of the present invention to enable viewers interested in differing features of the field of view to produce differing composite digital images from the same set of digital images of the field of view.

It is an object of the present invention to enable acquisition of digital images in a wide variety of illumination conditions without specialized hardware tailored to the illumination conditions. For instance, the invention could be used to replace both high-speed, low-light hardware and slower bright-light hardware.

It is an object of the present invention to enable adjustment of exposure properties, correction of motion blur and light streaks, and enhancement of motion blur and light streaks based on information contained in two or more digital images of the field of view rather than on information contained in a single digital image of the field of view.

It is an object of the present invention to reduce reliance on experience, luck, or automated parameter setting for visible light photographers seeking to obtain high-quality digital images.

Further objects and advantages of the invention will become apparent from a consideration of the ensuing description.

### DRAWING FIGURES

Not applicable

### REFERENCE NUMERALS IN DRAWINGS

Not applicable

### DESCRIPTION—IMAGING

Traditional analog photography and newer digital imaging techniques function in similar ways. In each, there are one or more sensors. In analog photography the single sensor is a plate or film coated with photosensitive chemicals. In digital imaging, the sensors may form sensor arrays of, for example, charge-coupled devices (CCDs), CMOS image sensors, piezoelectric crystals, or antennas.

A sensor is typically designed to have a linear response to incident energy over a finite response range. Within this range, the change in the sensor output during a finite exposure time is proportional to the total incident energy. Thus, a sensor can add up or integrate all the incident energy. However, beyond the finite response range, the response is no longer linear, and the change in sensor output is no longer a scaled integral of the incident energy. In this region, the sensor response is said to be saturated.

In forming a digital image, analog sensor outputs are mapped to digital number values via analog-to-digital (A/D) conversion. All analog values less than a minimum conversion level are mapped to a minimum digital number value. All analog values greater than a maximum conversion level are mapped to a maximum digital number values. Intermediate analog values are mapped to a finite set of intermediate digital number values. For instance, a popular mapping is the uniform mapping, in which each intermediate digital number value is assigned to analog values in range bins of equal width.

When quantizing analog values with an A/D converter, both the range and the resolution are important. Variations in absolute analog values less than the minimum conversion level or greater than the maximum conversion level cannot be captured. Also, variations on a scale smaller than the range bin size cannot be captured. For a fixed precision (i.e. number of bits), an A/D converter with a greater range typically has a lower resolution than an A/D converter with a smaller range.

Useful information in an image depends on variations in the image that accurately reflect variations in the incident energy that reaches the sensor array. Exposure properties of an image can be selected at the time of acquisition by controlling the amount of incident energy that reaches the array. Two ways to do this are via exposure time and aperture size. With the right combinations of exposure time and aperture size, a single array can be used in a wide variety of illumination conditions.

Given that many sensors are designed to integrate incident energy, changing the exposure time is an easy way to control incident energy. Reducing the exposure time reduces the amount of incident energy, and increasing the exposure time increases the amount of incident energy. Short exposure times are useful in conditions of strong illumination. However, a drawback of short exposure times is that small variations in incident energy may not appear in the acquired image. Long exposure times are useful in conditions of weak illumination because the integrals of small variations over a long period of time becoming larger variations. The drawbacks of long exposure times include the possibility of sensor output saturation and motion of features being imaged.

An aperture is a physical or synthetic opening through which incident energy passes in order to reach a sensor array. A smaller aperture permits less incident energy to reach the array than a larger aperture. Changing the size of an aperture is a way that incident energy can be controlled. Drawbacks of using aperture size as a control for incident energy include minimum and maximum aperture sizes, and possible limits on sizes in between.

The main purpose of choosing a combination of exposure time and aperture size that limit the amount of incident energy that reaches a sensor array is to exercise the full range of the sensor response and—for digital imaging—the A/D converter, without either analog or digital saturation and a corresponding loss of information.

Experienced photographers can usually choose an exposure time and an aperture size that produce an image in which the variations of incident energy corresponding to certain interesting features in a field of view are accurately represented in an acquired image, resulting in a “good” image. Inexperienced photographers may, by chance, select a proper combination. Both types of photographers may use automatic selection of exposure time and aperture size. Automatic techniques take some measurements of local or global illumination levels in the field of view just before image acquisition, and, based on some assumptions about interesting features in the field of view, select settings without manual intervention.

A difficulty with exposure adjustment at the time of imaging, whether manual or automatic, is that the actual features of interest in a field of view may be different from those identified during acquisition. A “good” image exercises the dynamic range of the interesting features. Variations in uninteresting features need not be accurately represented in the image. The catch is that differing features may be interesting features for differing image observers.

### DESCRIPTION—USEFUL DEFINITIONS

The ensuing description and claims make extensive use of terms that are subject to various interpretations. The intended interpretations and definitions of some of these are described in detail below.

In the present invention, the term “field of view” is used to describe an image, particularly what is being imaged. A field of view comprises a set of features occupying a volume of space. Each feature in the set emits or reflects energy which arrives at and is incident upon one or more sensors of a sensor array. A feature or object which emits or reflects energy which is not incident on any of the sensors during acquisition of an image is not part of the field of view of that image.

The relative positions of the features are also important in defining a field of view. However, image exposure time is finite, and features may experience motion. In light of these facts, it is intended that “field of view” should be interpreted as referring to a set of features that during acquisition of a first image are located in particular relative locations, or, in the case of motion, in particular sets of relative locations.

If, during acquisition of a second image, substantially the same features are located in substantially the same relative locations or in substantially the same sets of relative locations, the second image is of the same field of view as the first image.

If the second image of the same field of view is modified, but still comprises substantially the same set of features in substantially the same relative locations or in substantially the same sets of relative locations, the second image is of the same field of view as the first image.

The terms “arithmetic combining” and “arithmetic combination” are used extensively in the claims. Arithmetic combining or arithmetic combination involve modifying of one or more digital number values using basic arithmetic operations such as multiplication, addition, negation, subtraction, truncation, comparing, and rounding, as well as more complicated operations made up of sets of basic arithmetic operations.

Arithmetic combining and arithmetic combination are different from set combining. In set combining, digital number values are associated with one another as being members of a set, but the digital number values themselves are not changed. For instance, a red digital image, a green digital image, and a blue digital image together make up a color digital image. The color digital image comprises triplets of digital number values from the three component images. However, the values from the three component images are not arithmetically combined to form the color digital image.

Arithmetic combining or arithmetic combination and set combining or set combination can produce identical outputs given identical inputs. In such situations, the distinction between the two types of manipulation is that arithmetic combining and arithmetic combination have at least the possibility of modifying digital number values, whereas set combining and set combination do admit this possibility.

“Combining” or “combination” on their own are ambiguous, particularly when there is a great deal of prior art related to set combining. Digital image scanning techniques such as interlaced scanning or progressive scanning use set combining to build up a final acquired image. Image joining and photomontage techniques may use set combining separately from or in addition to arithmetic combining. A digital image can clearly also be redefined as several smaller digital images of several smaller fields of view, or as part of a larger digital image of a larger, artificial field of view.

It is the intent in the present invention that “field of view” be accorded some flexibility of definition as described above, so that attempts to circumvent the specific language of the claims of the present invention with regard to “field of view”, “arithmetic combining”, and “arithmetic combination” via set combining or set combination require substantial differences from the techniques of the present invention.

In particular, the inventor envisions that trivial modifications of digital images, such as addition or removal of one or more digital number values, might be used to create sets of digital number values which are then alleged to be of different fields of view. Alternatively, digital images might be split into different sets or associated in part or in full with different sets. Such redefining of digital images should have a useful purpose not foreseen in the present discussion, particularly if the end result of processing the redefined images is a composite digital image of the original field of view.

Description—the Preferred Embodiment

The preferred embodiment of the present invention as described in claim 1 is a machine used for exposure adjustment in digital imaging, comprising a first set of digital images of a field of view and arithmetic means for combining members of the first set to produce a composite digital image of the field of view.

The first set of digital images has as members at least two different digital images. A first digital image in the first set has a first pixel with a first exposure time and a second pixel with a second exposure time. The first pixel includes a first digital number value that represents signal levels of a sensor that responds to visible light. A second digital image in the first set has a third pixel and a fourth pixel.

The composite digital image of the field of view has a first composite pixel with a first composite exposure time and a second composite pixel with a second composite exposure time.

Arithmetic combining of two or more images to produce a composite image is not new, and is both easy to do and common in digital image processing. In the present invention, however, the combining is intended for exposure adjustment. The digital images and the composite digital image are of the same field of view, though they may have differing exposure properties.

Possible exposure properties that can be adjusted include exposure time, the range of variation in digital number values, the number of different digital number values that are possible, and artifacts such as motion blur or glints of light.

In particular, recall that the response of a sensor is commonly a linear function of incident energy over a finite response range, with the measured output value at the end of an exposure time being proportional to the integral of the incident energy. When the arithmetic means for combining uses addition of digital number values of corresponding pixels, it is possible to digitally emulate the effect of having a longer exposure time by summing the measured outputs from shorter exposure times. Thus it is possible to build up a desired range of variation in conditions of weak illumination. However, the digital images with the shorter exposure times may also include areas of strong illumination. These may not result in saturation for the shorter exposure times, but might result in saturation for the longer exposure times.

In other words, the present invention is intended to allow adjustment of the exposure properties of the composite digital image so that the variation of image values of features of interest exercises the full range of possible image values. Since it is often not known in advance what features are of interest to a given viewer, information about the variations in all the features of interest is preserved in the digital images in the first set. After acquisition of the digital images, various composite digital image can be produced.

Description—Alternative Embodiments

In an alternative embodiment of the invention, the third pixel and the fourth pixel of second digital image in claim 1 both contribute to the first composite pixel. Thus, more than one pixel from a single digital image in the first set of digital images can contribute to a composite pixel of the composite digital image.

In another alternative embodiment of the invention, the second pixel and the third pixel of claim 1 contribute to the first composite pixel. Pixels from more than one digital image in the first set of digital images can contribute to a composite pixel of the composite digital image.

In still another alternative embodiment of the invention of claim 1, the second pixel contributes to the first composite pixel, but the first composite exposure time is not identical to the second composite exposure time. In other words, the exposure time or exposure times of the composite digital image can be longer or shorter than the exposure times of contributing pixels from the digital images in the first set.

Longer exposure times can be obtained from addition of pixels with differing exposure times. For instance, the pixels might have identical exposure durations, but differing beginning and ending times for the exposure. Shorter exposure times can be obtained via subtraction of digital number values of pixels that have overlapping exposure times of suitable duration.

In another alternative embodiment of the invention, the first composite pixel is produced using a first arithmetic combining function and the second composite pixel is produced using a second arithmetic combining function that is not the same as the first arithmetic combining function.

While it is clearly possible to use a simple combining function such as the addition of corresponding pixels in differing digital images, an embodiment of the invention which uses differing combining functions is able to produce a composite digital image with desired local conditions. Recalling again that different viewers may find differing features in the field of view to be interesting, the availability of locally-varying combining functions allows precise adjustment of desired exposure properties of local features.

It is possible to produce a composite digital image of features in the field of view which in the image have comparable ranges of digital number values but which reflected or emitted different amounts of incident energy. Such an image would be analogous to an x-ray image with hard tissue and soft tissue features having comparable ranges of digital number values. However, with the present invention the image is possible in visible light without active illumination techniques.

Description—Alternative Embodiments with Feedback

In an alternative embodiment of the invention, the machine of claim 1 further includes means for evaluating exposure properties of the digital images to produce digital image exposure quality estimates and means for using said digital image exposure quality estimates to control the arithmetic means for combining the digital images.

This embodiment of the invention is intended to allow feedback control of the combining. For instance, one could have a first set of digital images of the field of view, with two digital images combined to produce a composite digital image if it is determined that none of the digital images are properly exposed. Then the invention could be applied recursively to a second set of digital images comprising the remaining members of the first set of digital images and the composite digital image. If none of these digital images are properly exposed, the composite digital image and a remaining member of the first set could be used to produce another composite digital image.

The means for evaluating the exposure properties of the digital images and for using the digital image exposure quality estimates could be part of an automated system for adjusting the exposure. On the other hand, they could involve manual intervention. For instance, a final composite picture may be generated by a viewer evaluating a number of possible digital images and composite digital images and selecting one that best meets the viewer's desires with regard to exposure properties.

In another alternative embodiment, the feedback can be used to determine that a member of the first set of digital images is properly exposed and to provide this image as the first composite digital image. Note that while the combining means does not necessarily modify this member in any way, this alternative embodiment has at least the possibility of producing a composite digital image which differs from all of the digital images in the first set.

An alternative embodiment of the invention based on feedback includes means for identifying changes in the relative position of an image feature in the digital images and means for modifying the changes in relative position when producing the composite digital image. In this embodiment, digital image exposure quality estimates can include identification of local or global motion effects in the digital images. Feedback of this information to the combining means by way of the modifying means allows compensation for or enhancement of the motion effects in the composite digital image.

Another possible feature that changes relative position is a bright glint of light in one or more digital images that is absent in other digital images. Depending on whether this bright glint is or is not desired in the final image, it can be included or excluded by the modifying means.

Description—An Alternative Embodiment for Active Imaging

Thus far, the invention has been applicable to passive imaging without an active source of imaging energy. Inasmuch as the embodiments of the invention have taken no specific account of the effects of an active imaging pulse, the embodiments are also applicable to active imaging.

An alternative embodiment of the invention which is designed for active imaging includes one or more digital images in the first set acquired in the presence of an active imaging pulse which has some energy in the form of visible light. Note that radar waves, infrared radiation, x-rays, and sound waves are not forms of visible light. However, an active imaging pulse that includes visible light may also have some infrared or ultraviolet light.

The alternative embodiment further includes means for identifying pixels of the digital images representative of the reflection of the active imaging pulse from image features in small areas of the field of view. These pixels are identified as pulse image pixels. The alternative embodiment also includes means for combing the digital images using the pulse image pixels to produce composite pixels with digital number values representative of the active imaging pulse reflected from the various small areas of the field of view.

In other words, portions of at least one of the digital images comprise reflections of the active imaging pulse from features in the field of view. Those portions may be illuminated well, while other portions may be poorly illuminated. When combining the digital images to produce the composite digital image, well-illuminated features from various digital images can be combined to mimic the effect of illumination of large portions of the field of view.

A prominent feature of flash photography in dark conditions is that the image usually captures the effects of the flash to a range of about 3 meters. The embodiment of the invention just above can be used to combine a sequence of digital images in which the flash is reflected from features at a variety of ranges. Then the composite image may appear to have a flash illumination of much longer duration and much greater range.

Description—Further Alternative Embodiments

An alternative embodiment of the invention includes a mobile electric power supply and means for powering the combining means with the mobile electric power supply. Examples of mobile electric power supplies include batteries, fuel cells, solar panels, and small generators. Such an embodiment of the invention can be mobile itself and can be used without a wire-line connection to a non-mobile electric power supply.

Another alternative embodiment of the invention includes a second set of two or more digital images of the field of view and arithmetic means for combining digital images from this second set to produce a second composite digital image of the field of view. This embodiment can be used to produce a sequence of composite digital images of the field of view, such as a video sequence. The exposure properties of the composite digital image sequence can differ from those of the digital image sequence.

An embodiment of the invention for exposure adjustment of image sequences allows filmmakers to acquire video footage and after acquisition to modify it to suit desired properties. For instance, a video camera adapted to low-light conditions may be immediately saturated in the presence of a bright light. Adaptation to the new bright light conditions requires a finite time. With the present invention, it is possible to produce a composite video sequence with a smooth transition between dark conditions and bright conditions.

As with embodiments for producing single composite digital images, this embodiment for producing multiple composite digital images allows novices who are not familiar with selecting proper combinations of aperture size and exposure time to produce good composite digital images.

In another alternative embodiment, the invention of claim 1 further includes means for acquiring digital images. Thus the invention can be part of a digital camera for acquiring still images or part of a digital video camera. The exposure adjustment can be automated at the time of image acquisition, or can be manually controlled while the image or images are in the acquisition device. This may be particularly useful when it is possible to have a single set with large number of digital images, but not a large number of such sets. Of course, it is also possible to modify the images with image processing hardware or software that are separate from the image acquisition system.

Description—Alternative Embodiments with A/D Conversion

In an alternative embodiment of the invention which includes means for acquiring images, there are a sensor with an initial signal level, means for exposing the sensor to incident energy, and means for representing the sensor response as a net signal level proportional to the difference between the sensor's final signal level and its initial signal level. There are also means for converting the net signal level to a digital number. An example of such means would be an analog-to-digital converter.

This alternative embodiment uses an absolute measurement of the change in signal level between the beginning of the sensor exposure time and the end of the sensor exposure time.

In another alternative embodiment, the sensor signal level changes to one or more intermediate signal levels during the exposure time. This embodiment includes means for representing the sensor response as one or more net signal levels. Each of the net signal levels is proportional to the difference between two signal levels from the set containing the initial signal level, the intermediate signal levels, and the final signal level.

This embodiment of the invention also includes means for converting one or more of the net signal levels to digital numbers. Whereas it was mentioned above that a high-quality digital imaging system has sensors with a linear response and an A/D converter with a dynamic range matched to the linear response range, the present alternative embodiment allows differential techniques. If, in a small portion of the sensor exposure time, the sensor response cannot change very much, then an A/D converter can have a dynamic range that is much smaller than the linear response region of the sensor. The digital number values from the net signal levels, which represent small differences, can be summed to produce digital number values for larger absolute changes in the sensor signal level.

In another alternative embodiment of the invention which is geared towards differential measurements rather than absolute measurements, the means for acquiring digital images includes switched-capacitor means for representing sensor signal levels. Switched-capacitor techniques are common in filtering. In digital imaging, for instance with a CMOS image sensor array, light incident on a sensor during one period of time could control charging of a capacitor. Light incident on the sensor during another period of time could control discharging of the capacitor or of another capacitor. The overall response of sensor during the exposure time could be represented as a set of differential charge measurements.

In another alternative embodiment of the invention, the means for acquiring the digital images includes a first sensor which contributes to the first digital image and not to the second digital image and a second sensor which contributes to the second digital image and not to the first digital image.

An example of this alternative embodiment would be a digital camera including a large sensor array. A subset of the sensors is used to acquire the first digital image, and a different subset of the sensors is used to acquire the second digital image. The camera might acquire the first digital image during a first short exposure time, with the second digital image acquired during a subsequent second short exposure time.

Description—Method Embodiments

In addition to the machine claims of the preferred embodiment of claim 1 and the alternative embodiments of following dependent claims, the present invention can have embodiments as a method for exposure adjustment in digital imaging. An independent method claim and several dependent method claims are included. These describe embodiments of the invention that are methods analogous to the machine claim embodiments described above.

Description—A Practical Embodiment

In a particularly useful embodiment of the present invention, there is a digital image acquisition device comprising a CMOS image sensor array and one or more fast A/D converters for quantizing the analog sensor outputs. The CMOS image sensors need not exercise their full linear range during the course of a single digital image acquisition and would not have to be re-initialized between each and every image acquisition. Instead, the A/D converters could have maximum and minimum conversion levels geared toward small differential changes in the sensor outputs during any given short exposure time. With the smaller input range, it would be possible to get higher resolution measurements from an A/D converter of a given precision.

Thus, the first set of digital images of the field of view would comprise a sequence of digital images of the field of view acquired during successive short exposure times. Obviously, the high-precision digital images would require a large amount of memory. However, the memory, along with the A/D converters, could be included on the same chip with the array of CMOS imaging sensors.

In bright light conditions, a composite digital image made from a small number of the digital images might contain suitable variation in the digital numbers representing differing features in the field of view. In low light conditions, a larger number of digital images might be needed for the composite digital image to have desired variation. Since the information about the locations of features during each of the short exposure times is preserved in the digital images, any undesired relative motion of the features could be compensated for in the composite image. For instance, if the digital image acquisition device is in a hand-held camera, the effects of a shaky hand can be removed.

Arithmetic combining of the digital images could be automated in the camera. Alternatively, the picture-taker might look at a series of possible composite digital images on a display screen of the camera and select one that is desired, with the digital pictures in the first set subsequently discarded. Alternatively, the digital pictures in the first set can be saved and later transferred to a personal computer in which image processing software could produce a desired composite digital image.

This practical embodiment of the invention would require careful design of a CMOS imaging array with fast A/D converters of moderate precision. Despite the increased cost of fast A/D converters relative to slow A/D converters, a single-chip implementation of the acquisition system would have a large existing market of personal and profession digital photographers. It would also, on the basis of the exposure adjustment capabilities of the present invention, result in a general-purpose digital camera which is easily used in a wide variety of light conditions. Since even novice photographers could acquire digital images which they could later arithmetically combine to produce good quality composite digital images, the invention would give even more people easy access to a useful technology.

Conclusion, Ramifications, and Scope

The reader will see that the present invention has several advantages over prior art techniques. Using the present invention, it is possible to use a set of digital images of a field of view to produce a composite digital image of the field of view with the composite digital image having exposure properties that differ from the exposure properties of the component digital images. For instance, the composite digital image can have proper exposure when the digital images are underexposed.

The description above contains many specific details relating to sensors, apertures, signal levels, underexposure, overexposure, linear response, saturation, experience, luck, desired features, enhancement, compensation, automated exposure setting, incident energy, active imaging, passive imaging, image processing, A/D conversion, minimum conversion level, maximum conversion level, dynamic range, precision, number mapping, quantization, digital images, and composite digital images. These should not be construed as limiting the scope of the invention, but as illustrating some of the presently preferred embodiments of the invention. The scope of the invention should be determined by the appended claims and their legal equivalents, rather than by the examples given.

I claim:

1. A machine used for exposure adjustment in digital imaging, comprising:
a. a first set of digital images of a field of view, said first set comprising at least two different digital images, with
i. a first digital image in said first set comprising a first pixel, said first pixel having a first exposure time and said first pixel comprising a first digital number value that represents signal levels of a sensor that responds to visible light
ii. said first digital image in said first set comprising a second pixel, said second pixel having a second exposure time
iii. a second digital image in said first set comprising a third pixel and a fourth pixel
b. arithmetic means for combining said digital images in said first set to produce a composite digital image of said field of view, with
i. said composite digital image having a first composite pixel having a first composite exposure time
ii. said composite digital image having a second composite pixel having a second composite exposure time
whereby said composite digital image can have desired exposure properties that differ from the exposure properties of the digital images from which it is formed.

2. The machine of claim 1 in which said third pixel and said fourth pixel contribute to said first composite pixel, whereby pixels from the same digital image in said first set can contribute to a single pixel in said composite digital image.

3. The machine of claim 1 in which said second pixel and said third pixel contribute to said first composite pixel, whereby pixels from different digital images in said first set can contribute to a single pixel in said composite digital image.

4. The machine of claim 1 in which:
a. said second pixel contributes to said first composite pixel
b. said first composite exposure time is not identical to said second exposure time
whereby said first composite exposure time is not the same as the exposure times of which it is composed, with possible differences including length, beginning times, and ending times.

5. The machine of claim 1 in which:
a. said first composite pixel is produced using a first arithmetic combining function
b. said second composite pixel is produced using a second arithmetic combining function
c. said first arithmetic combining function is not the same as said second arithmetic combining function
whereby different arithmetic combining functions can be used to produce the composite digital pixels of said composite digital image.

6. The machine of claim 1 further including:
a. means for evaluating exposure properties of said digital images to produce digital image exposure quality estimates
b. means for using said digital image exposure quality estimates to control said arithmetic means for combining said digital images
whereby, when said digital images are underexposed said composite digital image can be made to be properly exposed and not overexposed or underexposed, or, if desired, said composite image can be made to be overexposed or underexposed.

7. The machine of claim 6 in which said arithmetic means for combining said digital images in said first set can provide as said first composite digital image a member of said first set, whereby when said member of said first set has desired exposure properties, said arithmetic means for combining does not have to modify said member.

8. The machine of claim 6, further including:
a. means for identifying changes in the relative position of an image feature in said digital images of said field of view
b. means for modifying said changes in said relative position of said image feature when producing said composite digital image
whereby such effects as light streaks and motion blur can be compensated for or enhanced in said composite digital image.

9. The machine of claim 1 in which:
a. one or more members of said first set of digital images of said field of view are acquired in the presence of an active imaging pulse
b. said active imaging pulse comprises energy in the form of visible light
c. said machine of claim 1 further includes means for identifying pixels of said digital images which have digital number values representative of reflection of said active imaging pulse from image features in small areas of said field of view, said pixels being identified as pulse image pixels
d. said arithmetic means for combining said digital images uses said pulse image pixels to produce composite pixels which have digital number values representative of reflection of said active imaging pulse from image features in said small areas of said field of view
whereby said machine of claim 1 can be used to produce a composite digital image in which said active imaging pulse appears to illuminate a wide area of said field of view, which is useful in digital photography with a flash, where said active imaging pulse is not able to illuminate all areas of said field of view simultaneously.

10. The machine of claim 1 further including:
a. a mobile electric power supply
b. means for powering said arithmetic means for combining with said mobile electric power supply
whereby said machine of claim 1 can be powered by a device such as a battery, a fuel cell, a solar panel, or a generator so that said machine of claim 1 can be moved from place to place and used without a wire-line connection to a non-mobile electric power supply.

11. The machine of claim 1 further including:
a. a second set of two or more digital images of said field of view
b. arithmetic means for combining digital images from said second set to produce a second composite digital image of said field of view
whereby said machine of claim 1 can be used on a sequence of digital images to produce a sequence of composite digital images, whereby said machine of claim 1 can be used to produce a composite digital video sequence with desired exposure properties that differ from those of component digital video sequences.

12. The machine of claim 1 further including means for acquiring digital images, whereby said machine of claim 1 can be part of a digital imaging apparatus such as a digital camera for taking still images or a digital video camera.

13. The machine of claim 12 in which said means for acquiring digital images includes:
a. a sensor with an initial signal level
b. means for exposing said sensor to incident energy during a sensor exposure time, with said initial signal level changing to a final signal level
c. means for representing the response of said sensor during said sensor exposure time as a net signal level proportional to the difference between said final signal level and said initial signal level
d. means for converting said net signal level to a digital number
whereby said means for acquiring digital images uses absolute measurements of the change in signal levels during said sensor exposure time.

14. The machine of claim 12 in which said means for acquiring digital images includes:
a. a sensor with an initial signal level
b. means for exposing said sensor to incident energy during a sensor exposure time, with said initial signal level changing to one or more intermediate signal levels and then to a final signal level
c. means for representing the response of said sensor during said sensor exposure time as a set of one or more net signal levels each proportional to the difference between two of the signal levels in the set consisting of said initial signal level, said intermediate signal levels, and said final signal level
d. means for converting one or more of said net signal levels to digital numbers
whereby said means for acquiring digital images uses differential measurements of the change in signal levels during said sensor exposure time, so that an analog to digital converter with a much smaller input range than the range of the overall sensor signal level change can be used to acquire digital numbers representative of portions of the overall sensor signal level change.

15. The machine of claim 12 in which said means for acquiring digital images includes switched-capacitor means for representing sensor signal levels, whereby, particularly when using differential measurements, high-speed switched-capacitor filtering techniques can enable fast and accurate image acquisition.

16. The machine of claim 12 in which said means for acquiring digital images includes:
a. a first sensor which contributes to said first digital image and not to said second digital image
b. a second sensor which contributes to said second digital image and not to said first digital image
whereby a sensor array can be used to acquire said digital images, such as an array of charge-coupled devices in which a first set of charge-coupled devices produce said first digital image and in which a second set of charge-coupled devices produce said second digital image, with both sets of charge-coupled devices located on the same chip but allowed to respond to incident energy during different exposure times.

17. A method used for exposure adjustment in digital imaging, comprising arithmetic combination of digital images from a first set of digital images of a field of view to produce a composite digital image of said field of view, where:
a. said first set of digital images comprises at least two different digital images, with
i. a first digital image in said first set comprising a first pixel, said first pixel having a first exposure time and said first pixel comprising a first digital number value that represents signal levels of a sensor that responds to visible light
ii. said first digital image in said first set comprising a second pixel, said second pixel having a second exposure time
iii. a second digital image in said first set comprising a third pixel and a fourth pixel
b. said composite digital image:
i. comprises a first composite pixel having a first composite exposure time
ii. comprises a second composite pixel having a second composite exposure time
whereby said composite digital image can have desired exposure properties that differ from the exposure properties of the digital images from which it is formed.

18. The method of claim 17 in which said third pixel and said fourth pixel contribute to said first composite pixel, whereby pixels from the same digital image in said first set can contribute to a single pixel in said composite digital image.

19. The method of claim 17 in which said second pixel and said third pixel contribute to said first composite pixel, whereby pixels from different digital images in said first set can contribute to a single pixel in said composite digital image.

20. The method of claim 17 in which:
a. said second pixel contributes to said first composite pixel
b. said first composite exposure time is not identical to said second exposure time
whereby said first composite exposure time is not the same as the exposure times of which it is composed, with possible differences including length, beginning times, and ending times.

21. The method of claim 17 in which:
a. said first composite pixel is produced using a first arithmetic combining function
b. said second composite pixel is produced using a second arithmetic combining function
c. said first arithmetic combining function is not the same as said second arithmetic combining function
whereby different arithmetic combining functions can be used to produce the composite digital pixels of said composite digital image.

22. The method of claim 17 further including:
a. evalution of exposure properties of said digital images to produce digital image exposure quality estimates
b. using said digital image exposure quality estimates to control said arithmetic means for combining said digital images
whereby, when said digital images are underexposed said composite digital image can be made to be properly exposed and not overexposed or underexposed, or, if desired, said composite image can be made to be overexposed or underexposed.

23. The method of claim 22 in which said arithmetic combining said digital images in said first set can provide as said first composite digital image a member of said first set, whereby when said member of said first set has desired exposure properties, said arithmetic combining does not have to modify said member.

24. The method of claim 22, further including:
a. identifying changes in the relative position of an image feature in said digital images of said field of view
b. modifying said changes in said relative position of said image feature when producing said composite digital image
whereby such effects as light streaks and motion blur can be compensated for or enhanced in said composite digital image.

25. The method of claim 17 in which:
a. one or more members of said first set of digital images of said field of view are acquired in the presence of an active imaging pulse
b. said active imaging pulse comprises energy in the form of visible light
c. said method of claim 17 further includes identifying pixels of said digital images which have digital number values representative of reflection of said active imaging pulse from image features in small areas of said field of view, said pixels being identified as pulse image pixels
d. said arithmetic combining said digital images uses said pulse image pixels to produce composite pixels which have digital number values representative of reflection of said active imaging pulse from image features in said small areas of said field of view
whereby the method of claim 17 can be used to produce a composite image in which said active imaging pulse appears to illuminate a wide area of said field of view, which is useful in digital photography with a flash, where said active imaging pulse is not able to illuminate all areas of said field of view simultaneously.

26. The method of claim 17 further including powering said arithmetic combining with a mobile electric power supply, whereby the method of claim 17 use for power a device such as a battery, a fuel cell, a solar panel, or a generator so that the method of claim 17 can be used while moving from place to place and without a wire-line connection to a non-mobile electric power supply.

27. The method of claim 17 further including arithmetic combining of digital images from a second set of two or more digital images of said field of view to produce a second composite digital image, whereby said method of claim 17 can be used on a sequence of digital images to produce a sequence of composite digital images, whereby said method of claim 17 can be used to produce a composite digital video sequence with desired exposure properties that differ from those of component digital video sequences.

28. The method of claim 17 further acquiring of digital images, whereby said method of claim 17 can be part of a digital imaging method such as a digital camera method for taking still images or a digital video camera method.

29. The method of claim 28 in which said acquiring of digital images includes:
a. exposing a sensor with an initial signal level to incident energy during a sensor exposure time, with said initial signal level changing to a final signal level
b. representing the response of said sensor during said sensor exposure time as a net signal level proportional to the difference between said final signal level and said initial signal level
c. converting said net signal level to a digital number
whereby said acquiring of digital images uses absolute measurements of the change in signal levels during said sensor exposure time.

30. The method of claim 28 in which said acquiring of digital images includes:
a. exposing a sensor with an initial signal level to incident energy during a sensor exposure time, with said initial signal level changing to one or more intermediate signal levels and then to a final signal level
b. representing the response of said sensor during said sensor exposure time as a set of one or more net signal levels each proportional to the difference between two of the signal levels in the set consisting of said initial signal level, said intermediate signal levels, and said final signal level
c. converting one or more of said net signal levels to digital numbers
whereby said acquiring of digital images uses differential measurements of the change in signal levels during said sensor exposure time, so that an analog to digital converter with a much smaller input range than the range of the overall sensor signal level change can be used to acquire digital numbers representative of portions of the overall sensor signal level change.

31. The method of claim 28 in which said acquiring of digital images includes representing sensor signal levels using switched-capacitor methods, whereby, particularly when using differential measurements, high-speed switched-capacitor filtering techniques can enable fast and accurate image acquisition.

32. The method of claim 28 in which said acquiring of digital images includes:
a. contribution of a first sensor to said first digital image and not to said second digital image
b. contribution of a second sensor to said second digital image and not to said first digital image
whereby a sensor array method can be used for acquiring said digital images, such as an array of charge-coupled devices in which a first set of charge-coupled devices produce said first digital image and in which a second set of charge-coupled devices produce said second digital image, with both sets of charge-coupled devices located on the same chip but allowed to respond to incident energy during different exposure times.
